(19) United States
(12) Patent Application Publication
(10) Pub. No.: US 2007/0095744 A1
(43) Pub. Date: May 3, 2007

(54) Fluid filter with open-end flow, replaceable cartridge

(76) Inventors: Ismail C. Bagci, Cookeville, TN (US); Kevin C. South, Cookeville, TN (US); Jeffrey B. Sharp, Cookeville, TN (US)

Correspondence Address: KRIEG DEVAULT LLP, ONE INDIANA SQUARE, SUITE 2800, INDIANAPOLIS, IN, 46204-2079, US

(21) Appl. No.: 11/264,473

(22) Filed: Nov. 1, 2005

(51) Int. Cl. B01D 35/28

(52) U.S. Cl. 210/435; 210/455; 210/445

(57) ABSTRACT

A fluid filter for the processing of a circulating fluid includes a unitary, molded plastic shell including an annular sidewall defining an open interior space and an annular entrance opening, the sidewall including an exposed edge that is formed with a plurality of recessed slots, a fluid filter cartridge inserted into the interior space of the shell and including a filtering media element and bonded thereto a molded plastic endplate. The endplate includes a plurality of outwardly-extending projections that cooperatively fit into said plurality of recessed slots for fixing the position of the fluid filter cartridge relative to the shell in terms of the axial depth of the cartridge into the shell and for preventing relative rotation or movement between the cartridge and shell.

### BACKGROUND OF THE INVENTION

The present invention relates in general to a fluid filter incorporating a plastic shell and a replaceable fluid filter cartridge. More specifically, the present invention relates to configuring the shell so that it will only accept, in terms of proper functioning, a cooperatively-configured replaceable fluid filter cartridge.

One of the emerging technologies in terms of fluid filter construction is the enlargement of the threaded connection interface between the molded plastic shell and the fluid-delivery head, accompanied by the elimination of the typical or traditional nutplate. In one embodiment of this design concept, the shell is molded out of plastic and the outer cylindrical surface of the shell adjacent the open end of the shell is externally threaded. This threaded surface of the shell is used to attach the shell, and in turn the fluid filter assembly, to the head. This style of shell is configured for use with a spin-on style of filtration system as part of a disposable fluid filter assembly.

Some end users of the type of filtration systems described above enjoy the advantages gained from a replaceable fluid filter cartridge. Therefore, it would be an advance in the state of the art to configure the molded plastic shell, generally as described above, but configured to accept a replaceable fluid filter cartridge. Related to the acceptance of a replaceable cartridge is the inability of the shell to accept a spin-on style of filter as part of a disposable, single-use system. The fluid filter construction disclosed herein is directed to providing this capability by the design of a novel and unobvious fluid filter endplate with cooperative modifications to the upper exposed edge of the shell that defines the open end of the shell.

### BRIEF SUMMARY OF THE INVENTION

A fluid filter assembly for the processing of a circulating fluid according to one embodiment of the present invention comprises a shell including a sidewall that defines an interior space and an entrance opening at one end of the shell, the sidewall including an exposed edge adjacent the entrance opening, a fluid filter cartridge installed into the shell resulting from insertion of the fluid filter cartridge into the interior space by way of the entrance opening, the fluid filter cartridge including a filtering media element and an endplate that is attached to one end of the filtering media element, and a structural interface configured for fixing the axial depth of the fluid filter cartridge into the shell, the structural interface including a plurality of first forms configured as part of the exposed upper edge of the shell and a plurality of second forms configured as part of the endplate, the first forms and the second forms being constructed and arranged to cooperatively interfit with each other for fixing the axial depth of the fluid filter cartridge into the shell.

One object of the present invention is to provide an improved fluid filter assembly.

Related objects and advantages of the present invention will be apparent from the following description.

### BRIEF DESCRIPTION OF THE SEVERAL VIEWS OF THE DRAWINGS

FIG. 1 is a front elevational view of a fluid filter assembly according to a typical embodiment of the present invention.

FIG. 2 is a side elevational view of the FIG. 1 fluid filter assembly, in full section.

FIG. 3 is a front elevational view of the FIG. 1 fluid filter assembly, in full section.

FIG. 4 is an exploded view of the FIG. 1 fluid filter assembly.

FIG. 5 is a front elevational view of a fluid filter cartridge comprising one portion of the FIG. 1 fluid filter assembly.

FIG. 6 is a front elevational view of a molded plastic housing comprising a portion of the FIG. 1 fluid filter assembly.

FIG. 6A is a partial, enlarged detail view of one slot style defined by the FIG. 6 shell.

FIG. 6B is a partial, enlarged view of a second slot style also defined by the FIG. 6 shell.

FIG. 7 is a side elevational view of the FIG. 6 shell.

FIG. 8 is a perspective view of the FIG. 6 shell.

FIG. 9 is a top plan view of a molded plastic endplate comprising a portion of the FIG. 5 fluid filter cartridge.

FIG. 10 is a front elevational view of the FIG. 9 endplate.

FIG. 11 is a perspective view of the FIG. 9 endplate.

FIG. 12 is a perspective view of a removal procedure for the FIG. 5 fluid filter cartridge from the FIG. 6 housing.

FIG. 13 is a partial perspective view of the fluid filter assembly showing one flow clearance space for entering fluid.

### DETAILED DESCRIPTION OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

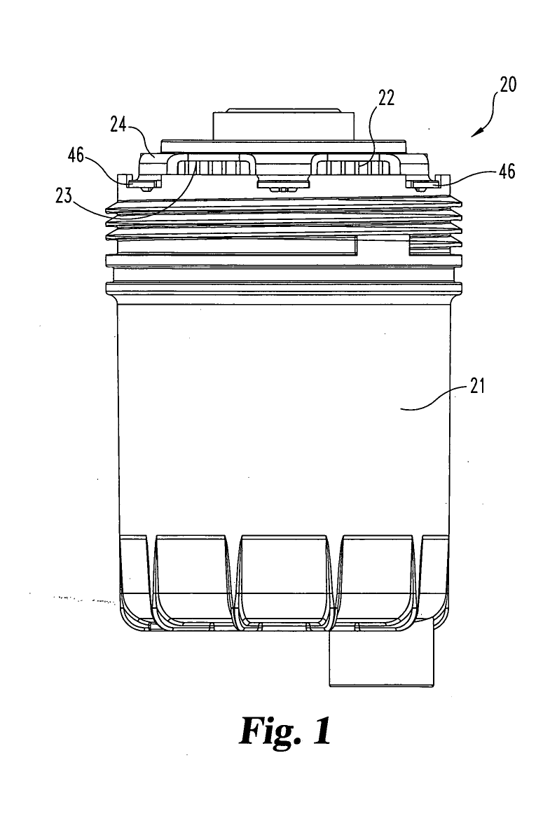

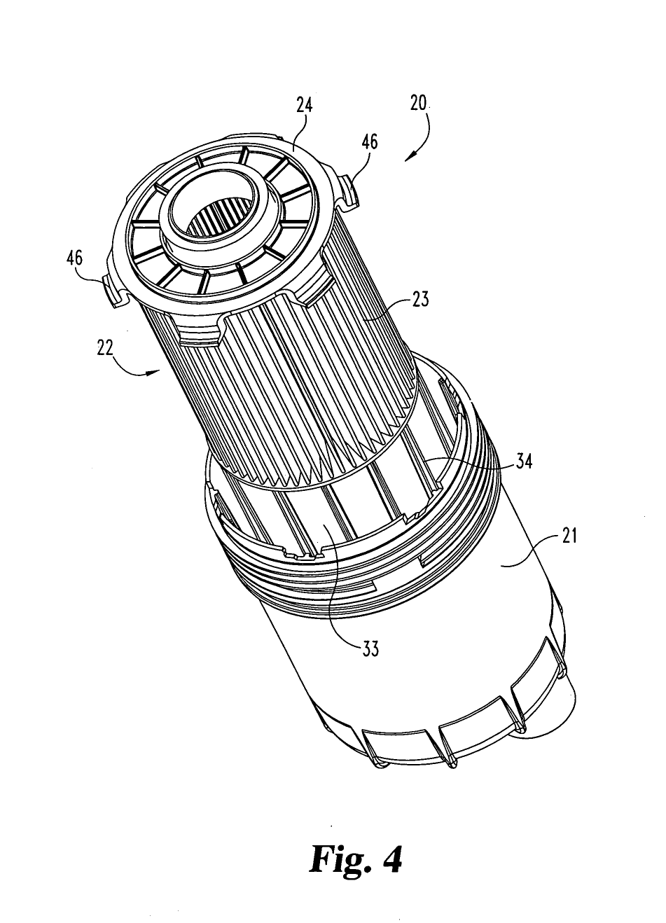

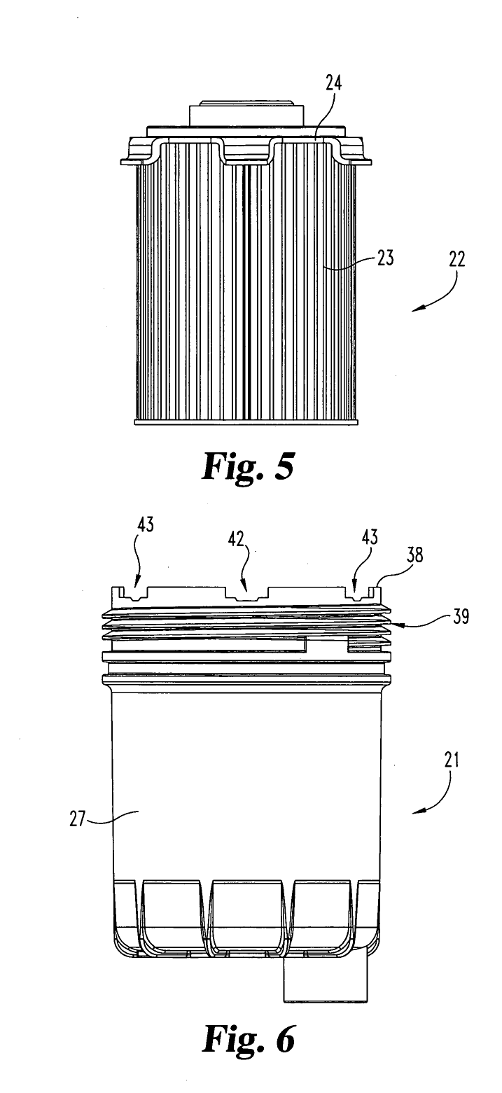

Referring to FIGS. 1-5, there is illustrated a fluid filter assembly 20 that is constructed and arranged for threaded connection to a fluid-delivery mounting head (not illustrated). Fluid filter assembly 20 includes a unitary, molded plastic shell 21 and a cooperating fluid filter cartridge 22. The fluid filter cartridge 22 (see FIG. 5) includes a generally cylindrical filtering media element or filter media pack 23 and a unitary, molded plastic endplate 24 that is securely attached, such as by adhesive bonding, to the upper end of the filter media pack 23.

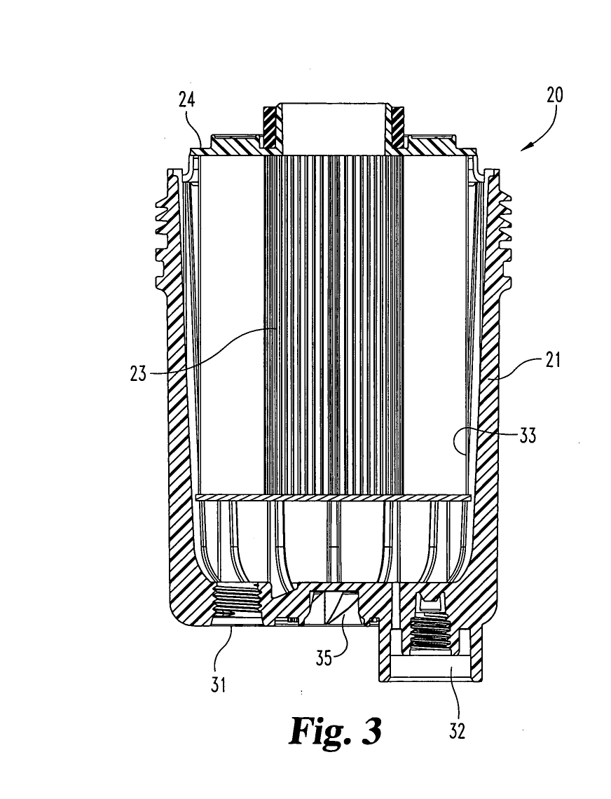

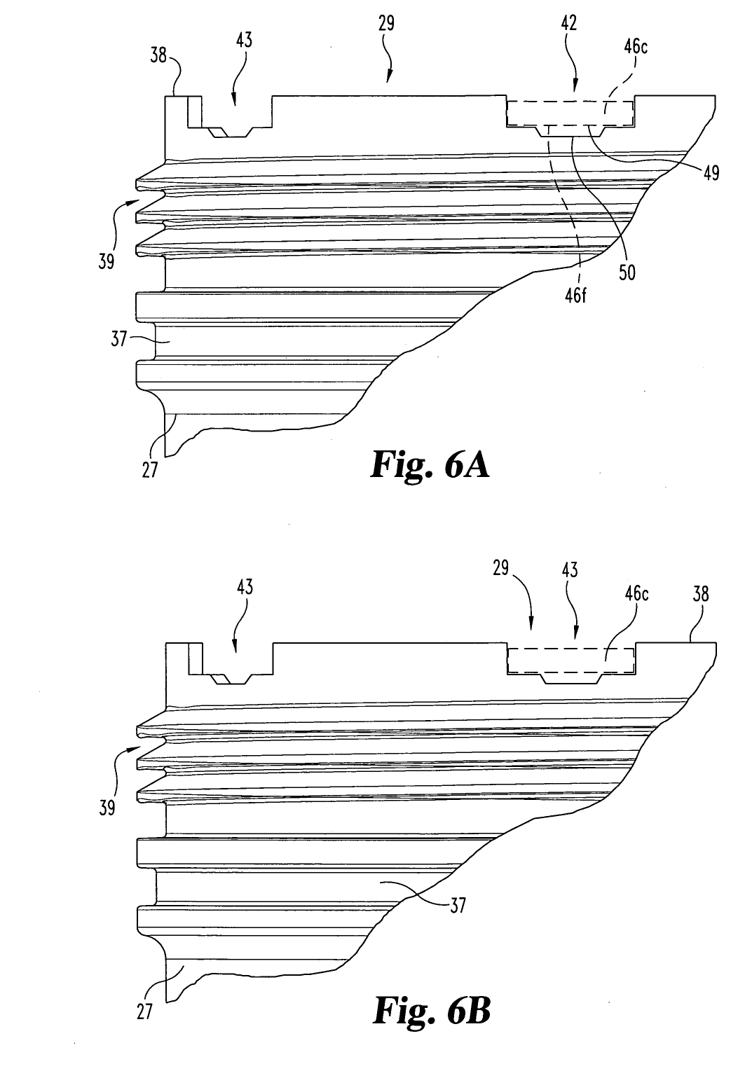

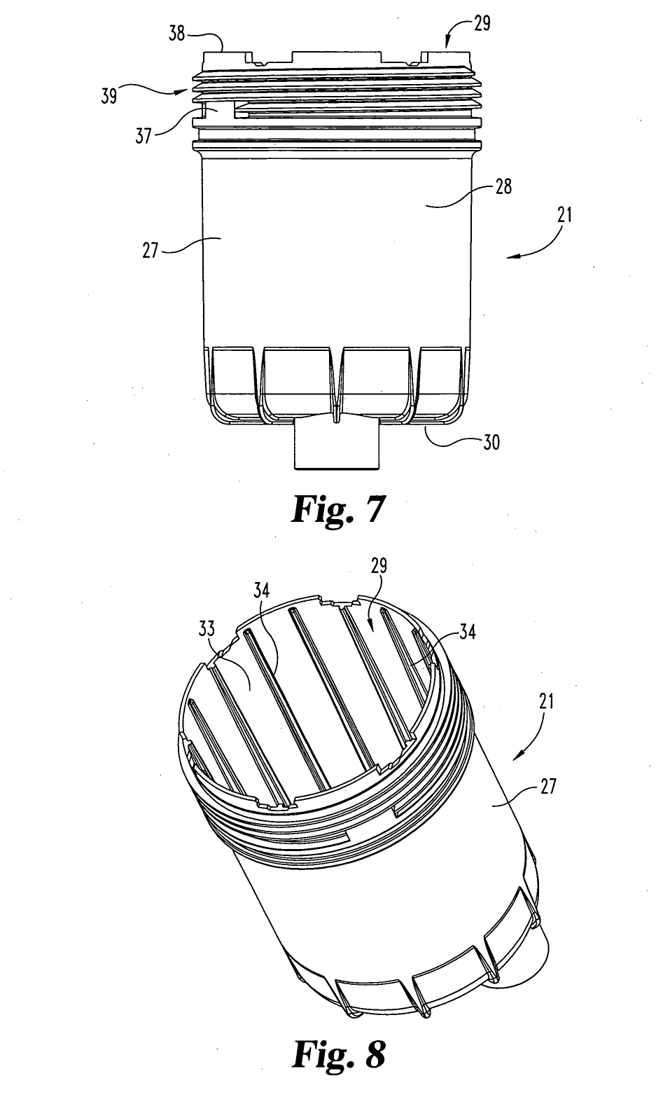

Referring to FIGS. 6-8, the details of plastic shell 21 are illustrated. The generally cylindrical body 27 includes an annular sidewall 28 that defines open end 29. The plastic shell also includes a closed base 30 that is integral with cylindrical body 27. While the base 30 is described as “closed”, there are two defined apertures 31 and 32 (see FIG. 3). These two defined apertures provide the capability of water-in-fuel (WIF) sensing (31) and water drainage (32) for the fluid filter assembly 20. The additional socket 35 is for a one-way removal feature. The inner surface 33 of sidewall 28 includes a uniformly spaced-apart series of structural ribs 34. Ribs 34 are unitarily molded as part of shell 21 and provide structural support and rigidity to the shell as well as a deterrent against the attempted use of any non-standard filter media, such as a spin-on filter style intended for single-use as part of a disposable fluid filter assembly. One feature of note, though not actually illustrated, is the elimination from these inner ribs 34 of any type of rib ledge or shelf that would typically be used to support the filtering element (spin-on, single-use style) as depicted in certain prior constructions. Eliminating any type of rib ledge or shelf and extending ribs 34 axially provides the mentioned structural support to shell 21 and eliminates any support structure that might otherwise control the axial depth of an installed fluid filter cartridge. This structural design change to the shell 21 in turn requires some utilization of the open end 29 in order to control the insertion depth of any fluid filter or filter media pack into the shell 21.

The outer surface 37 of sidewall 28 adjacent upper edge 38 of open end 29 is constructed and arranged with a series of molded threads 39 that are used to securely attach fluid filter assembly 20 to the fluid-routing head (not illustrated). Further, the sidewall 28, in cooperation with the closed base 30, defines a generally cylindrical interior space for shell 21 that is constructed and arranged to receive the fluid filter cartridge 22. Upper edge 38 that helps to define open end 29 is considered to be an exposed or free edge and open end 29 constitutes the entrance opening of the shell, noting that the opposite end of the shell includes closed base 30. As noted, the fluid filter cartridge 22 is installed into the shell by inserting the fluid filter cartridge into the interior space by way of this entrance opening.

Shell 21 represents the type of molded plastic shell that is used without a “nutplate” as that component term would be understood to mean as part of conventional fluid filter terminology. The enlarged series of outer threads 39, in terms of the outside diameter size of shell 21, requires a unique or special head design so as to change from the head structure that would be used for head connection to a nutplate. Shell 21 is constructed and arranged so as to reject or prevent the insertion of a spin-on style of fluid filter. In terms of generally accepted terminology, the understanding of a spin-on, single-use filter is that the overall fluid filter assembly would be considered as disposable after a single use cycle. Structurally, the wall thickness can be somewhat less for a single use filter assembly as compared to the desire for a slightly thicker wall when the shell is designed for multiple uses., i.e., reuse with replaceable fluid filter cartridges, as presented for the disclosed invention. If the same basic shell shape is going to be used for both types of fluid filter assemblies, disposable as well as multiple use, various design changes will be made.

Reference to the same basic shell shape means that the exterior size and shape are generally the same whether the intended end use is as part of a spin-on, disposable fluid filter assembly or as part of a fluid filter assembly that includes a replaceable filter cartridge. There are though differences between these two styles of filter assemblies in terms of the final shell configurations. While the overall basic shell shape may begin somewhat the same for these two styles of fluid filter assemblies, the inner core for the interior molding of the shell is sized and shaped differently depending on the particular fluid filter assembly style that will utilize the particular shell.

As for some of the shell design differences, the spin-on, disposable style does not require any notches or slots, as shown in FIGS. 6, 6A and 6B, while the replaceable, cartridge style requires these notches. For the spin-on, disposable style, radial ledges are used as part of the structural ribs on the interior of the shell to position the fluid filter element and to set its axial height down into the interior of the shell. The replaceable cartridge style does not use any radial ledges since its axial depth and positioning are controlled by the endplate configuration and its interfit into the spaced series of six notches or slots 42 and 43. When the rib ledges are molded as a part of the unitary plastic shell, the interior space of the shell is described as having an interior abutment ledge. This is the surface that supports or otherwise positions the lower portion of the installed fluid filter element to maintain the proper axial depth of that element into the shell. When the inwardly extending radial rib ledges are not molded as part of the shell interior, then the shell interior space is described herein as being “open”.

If a spin-on, disposable style of fluid filter assembly is selected, the core diameter for the shell molding process is increased in size, resulting in a thinner wall as compared to the increased wall thickness desired for the replaceable, fluid filter cartridge style. This difference in wall thickness assumes that the overall outer size and shape of the shell is basically the same for both of these fluid filter assembly styles. It is simply a reality that when the fluid filter assembly is designed as a single-use, disposable assembly, the shell wall thickness does not have to be as great as when the shell is used and re-used multiple times. Varying the shell wall thickness is achieved by varying the inserted core diameter during the molding process. Since these fabrication differences between the two styles of shells can be integrated into the same production line, there are some resulting efficiencies. While these efficiencies are important and while the ability to use the same basic style of shell is important, the present invention focuses more on the replaceable, fluid filter cartridge design and the manner in which the cartridge and shell cooperate with one another, as disclosed herein.

The use of a fluid filter assembly that is configured for use with a replaceable cartridge style filtering element provides various features that some end users prefer and see as advantages as compared to a disposable, single-use fluid filter assembly. For example, when the shell is reused, there is less associated scrap and there is reduced service interval cost. The use of a replaceable fluid filter cartridge permits the easy change (replacement) of the fluid filter cartridge by simply pulling out the used fluid filter cartridge and inserting a new fluid filter cartridge into the interior space of the shell.

In order for shell 21 to be configured for use with a replaceable cartridge style of fluid filter element, according to what is disclosed herein, the upper exposed edge 38 is configured with a series of six (6) recessed notches or slots (see FIGS. 6, 6A and 6B). In the preferred embodiment that is illustrated, there are two slots 42 that are constructed and arranged with a first shape and four slots 43 that are constructed and arranged with a second shape that is slightly different from the first shape. In one arrangement of the disclosed fluid filter assembly, these six slots 42 and 43 are equally spaced around upper edge 38. For this one arrangement of six (6) slots, the replaceable fluid filter cartridge 22 can be installed in any one of six orientations in terms of its rotation relative to the shell, as will be described herein as part of the description of the fluid filter cartridge 22 and endplate 24. In a second arrangement, the spacing between the series of six (6) slots 42 and 43 is not equal, but random or varied, such that there is only a single orientation for the fluid filter cartridge to insert. into the shell 21. Going to a varied spacing for the six slots requires a corresponding varied spacing for the projections 46 of the endplate 24, as described herein. Since the random spacing between slots 42 and 43 may not be a high priority with a majority of end users, the focus of the present disclosure is on equal spacing where the notch or slot centerlines are sixty degrees apart and the replaceable, fluid filter cartridge 22 is able to be installed in the shell in any one of six positions.

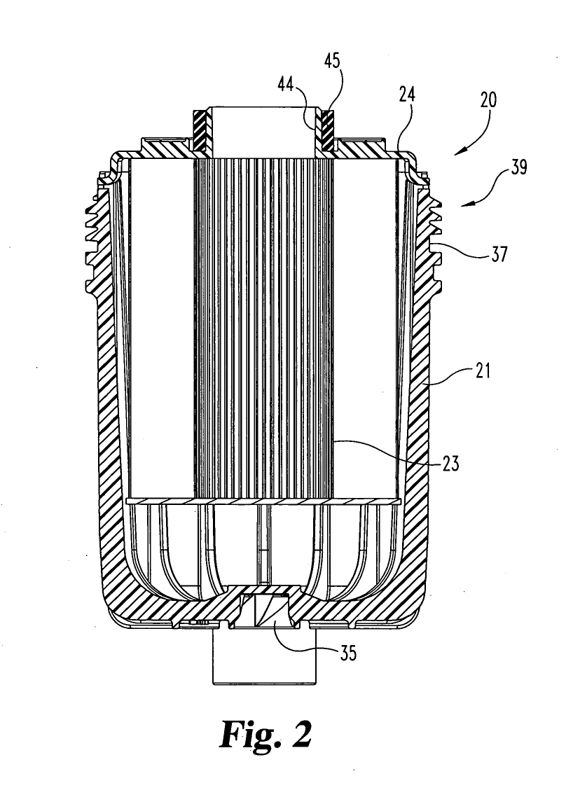

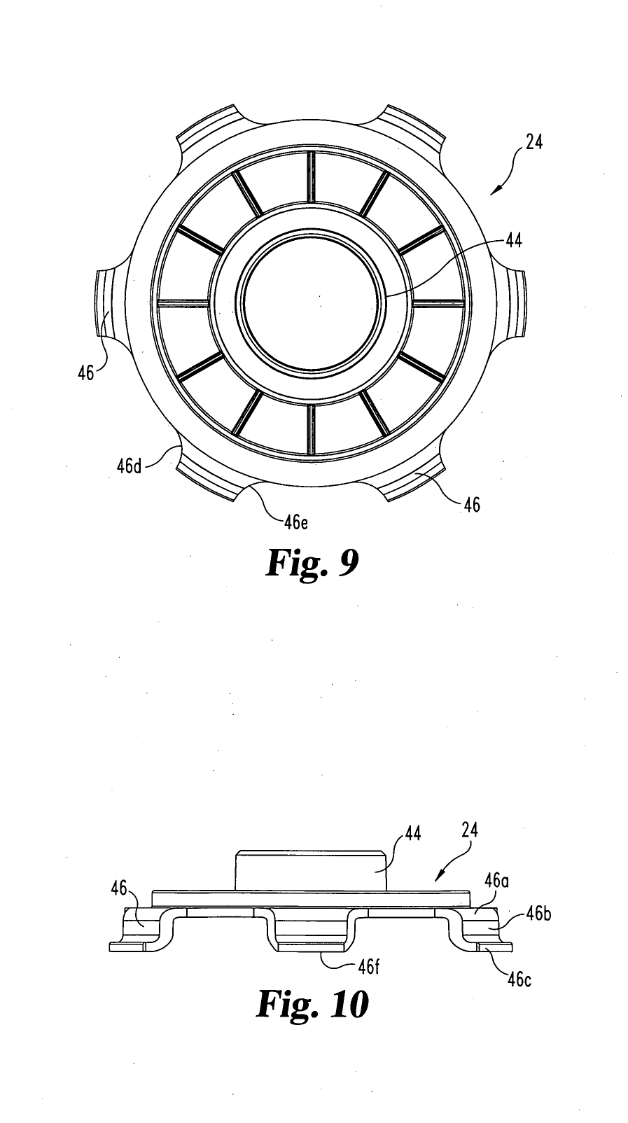

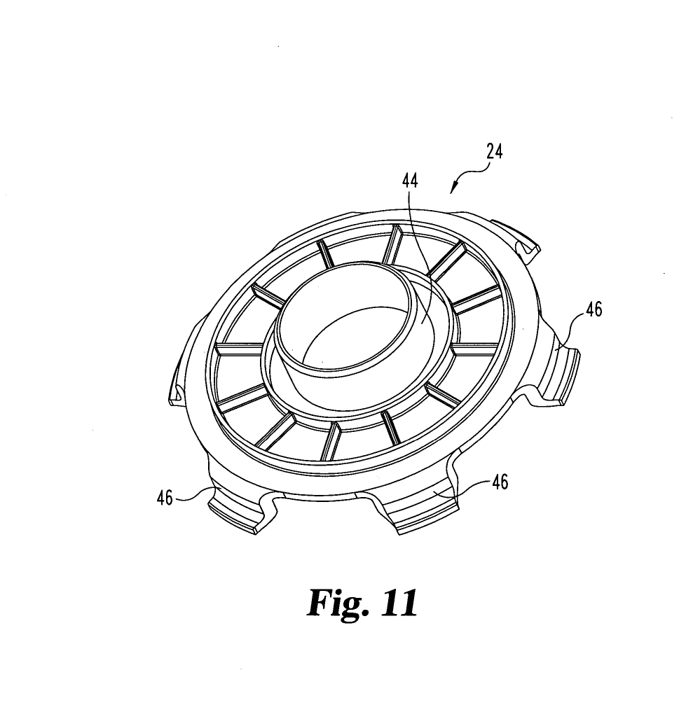

Referring to FIGS. 9-11, the details of plastic endplate 24 are illustrated. The filtering media pack 23 is a generally cylindrical, pleated, filtering media structure or element and the plastic endplate 24 is adhesively bonded to the upper exposed end of the filter media pack 23 in order to create fluid filter cartridge 22. Endplate 24 is a unitary, molded plastic component that includes an open cylindrical sleeve 44 for receipt by the head for routing of the exiting fluid after it passes through the filtering media pack 23. An annular face seal (sealing) gasket 45 is positioned around sleeve 44 (see FIGS. 2 and 3) for a liquid-tight sealed interface between the endplate 24 and the head. As the shell threads onto the head, the gasket 45 engages a surface of the head causing gasket compression with continued threaded engagement.

Seating of the fluid filter cartridge 22 into shell 21 is achieved by the use of slots 42 and 43 and cooperating outwardly-extending radial projections 46. There are six projections 46 that are constructed and arranged to match the spacing of the slots 42 and 43. Each projection 46 has an L-shaped form with an upper, outwardly extending section 46a, an axially depending section 46b, and a lower, outwardly extending radial lip 46c. While there are two styles of slots 42 and 43 as described and as will be explained in greater detail, all six projections 46 are constructed and arranged with the same size and shape. Each projection 46 includes concave side surfaces 46d and 46e (see FIG. 9), creating the appearance of an outwardly tapering shape for each projection 46. Radial lip 46c is constructed and arranged with a generally horizontal, substantially flat lower surface 46f.

As is illustrated and as would be understood from the foregoing descriptions, upper edge 38 of sidewall 28 defines open end 29. The inside diameter surface of upper edge 38 (or sidewall 28 at its upper end) coincides with the outside diameter of the open area of the generally circular open end 29. In order to guarantee that the fluid filter cartridge 22 uses upper edge 38 for the positioning of cartridge 22 within shell 21, the outside diameter dimension of the endplate 24, as measured over or across the outer tips of the projections 46, exceeds the outside diameter of the open area of open end 29. It is also noted that the outside diameter across the outer tips of projections 46 does not extend beyond the outside diameter of shell 21, at least not to any noticeable degree or extent that would potentially interfere with the threaded connection of the shell 21 to the head.

In terms of the number of slots and the number of projections, it will be noted that the proper assembly of the fluid filter cartridge 22 into shell 21 requires a receiving slot, either 42 or 43, for each projection 46. If there are any slots in upper edge 38 that do not receive a projection 46, then there is a gap left at that location on edge 38. If there is an “extra projection 46 that does not have a corresponding receiving slot, properly sized and positioned, it will cause interference with the upper edge 38 of shell 21 at the time of attempted installation of the cartridge 22 into the shell 21. This interference of a projection 46 resting on top of edge 38 prevents proper seating of the fluid filter assembly against the head. The assembly and proper seating of fluid filter cartridge 22 into shell 21 is illustrated in FIGS. 2 and 3. This proper seating positions each projection 46 down into a corresponding one of the receiving slots 42, 43. The two slots 42 are constructed and arranged for a secure capture of the inserted projection 46 by an interference fit. The other four slots 43 are each constructed and arranged for a close clearance receiving fit of their corresponding projection 46. These other four slots 43 provide support for the fluid filter cartridge 22. All six slots 42, 43 cooperate with their receiving projections 46 in order to set the desired insertion depth of the fluid filter cartridge 22 into shell 21. The interfit between the projections 46 and slots 42, 43 also prevents any rotation of the fluid filter cartridge 22 relative to shell 21, once the fluid filter cartridge is properly installed. It will also be noted from the various figures that each projection 46, specifically the radial lip 46c, is recessed below the upper surface of exposed upper edge 38. The number of slots 42 and the complementing number of slots 43 can be varied from 6-0 to 0-6 and all combinations between these extremes. If added security is desired in terms of physically capturing one or more of the projections 46, then the side walls of the receiving slot can be shaped with detent ribs or bumps for a snap fit.

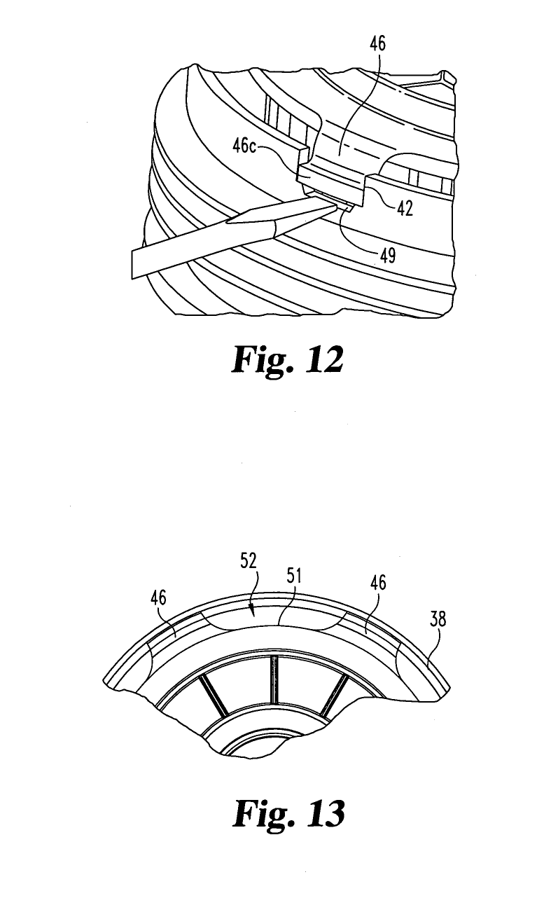

Slot 42 is illustrated in greater detail in FIG. 6A and slot 43 is illustrated in greater detail in FIG. 6B. The broken line outline in each of these two drawing figures represents the shape and proper positions of section 46c of the received projection 46. The construction and arrangement of each slot 42 creates a sufficiently tight interference fit with the received projection 46 to anchor and hold the fluid filter cartridge 22 into shell 21. As illustrated, a small clearance space 49 is defined beneath section 46c and is located between lower surface 50 of slot 42 and the flat lower surface 46f of the corresponding projection 46. The clearance space 49 is used to receive the flat tip of hand tool, such as a screwdriver, in order to be able to pry up on the corresponding projection 46 that is received within slot 42 in order to pop the projection free of its interference fit (see FIG. 12). As noted, it is not possible to install the fluid filter cartridge 22 unless the correct shell 21 has been selected.

Due to the outwardly extending design of projections 46 in a radially outward direction from the outer circular edge 51 of endplate 24, flow clearance spaces 52 are defined between each pair of adjacent projections 46. See FIG. 13 for one example of a defined flow clearance space 52. These clearance spaces provide the necessary flow channels into shell 21 for the fluid to be filtered by the filtering media element. The outline of each clearance space 42 is defined by the inner surface of upper edge 38, the outer circular edge 51, and the adjacent pair of projections 46. These six clearance spaces 52 provide a flow path for the fluid to be filtered that arrives by way of the head and flows onto the endplate outside of the return flow sleeve 44. This allows faster and smoother routing of the fluid flow in view of the number and size of the flow openings (i.e., clearance spaces 52) and enables more efficient fluid filtration and processing. As the fluid to be filtered flows across the exposed surface of the endplate, it reaches the flow clearance spaces 52 and flows through these spaces to the annular clearance space defined by and between the inside surface 33 of the sidewall 28 and the outer cylindrical surface (pleated) of the filter media pack 23.

The style of fluid filter cartridge 20 described herein includes a couple of additional benefits to the end user in terms of performance, simplicity, and cost. The cartridge endplate 24 and cooperating shell 21 eliminate the possibility that an incorrect or improper fluid filter cartridge will be installed. Any cartridge without the proper number, style, and spacing of endplate projections 46 will not fit “properly” into the shell 21. The elimination of the rib ledge structures from the axially extending ribs 34 means that there is nothing to support the non-approved fluid filter cartridge when inserted into the shell and there is nothing to set or control the desired depth for the cartridge except for the upper edge 38 of sidewall 28 of shell 21. If the upper edge is attempted to be used in some manner to control the depth of the cartridge, it means that the edge cannot fit flush against or within the head. This also prevents proper compression of the gasket or seal and will result in leakage. The only option for a proper assembly and proper fit to the head is to utilize slots 42 and 43 with the designed number of cooperating projections as part of the endplate. However, that cooperating structure would mean an endplate conforming to the configuration of endplate 24 and thus the only fluid filter cartridge fully compatible with shell 21 is to use one that is designed to cooperate with slots 42 and 43. The retention capability afforded by the interference fit and insertion of projections 46 into slots 42 and 43 means that there will be an important retention feature during the assembly process.

Another benefit derived from the cartridge 22 and shell 21 combination is the option for an increased media area. By using the endplate 24 and the upper edge 38 to set the axial depth of cartridge 22, the media portion of the cartridge can be longer. As compared to other designs using the rib ledges for cartridge positioning, the longer media portion means more media and an increased media area. The present invention raises the upper edge of the cartridge closer to edge 38 and the opposite end can be extended deeper into the shell.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A fluid filter assembly for the processing of a circulating fluid, said fluid filter comprising:
a shell including a sidewall that defines an interior space and an entrance opening at one end of said shell, said sidewall including an exposed edge adjacent said entrance opening;
a fluid filter cartridge installed into said shell resulting from insertion of said fluid filter cartridge into said interior space via said entrance opening, said fluid filter cartridge including a filtering media element and an endplate that is attached to one end of said filtering media element; and
positioning means for fixing the axial depth of said fluid filter cartridge into said shell, said positioning means including a plurality of first forms configured as part of said exposed upper edge and a plurality of second forms configured as part of said endplate, said first forms and said second forms being constructed and arranged to cooperatively interfit with each other for fixing said axial depth of said fluid filter cartridge into said shell.

2. The fluid filter assembly of claim 1 wherein said plurality of first forms are defined by said exposed upper edge and shaped as open receiving slots.

3. The fluid filter assembly of claim 2 wherein said plurality of second forms include radially outwardly extending projections.

4. The fluid filter assembly of claim 3 wherein there is a one-to-one correspondence in the number of first forms and the number of second forms.

5. The fluid filter assembly of claim 4 wherein at least one receiving slot of said plurality of receiving slots has an interference fit with its corresponding projection.

6. The fluid filter assembly of claim 5 wherein said interior space of said shell is open.

7. The fluid filter assembly of claim 6 wherein said shell is a unitary, molded plastic structure, and wherein said endplate is a unitary, molded plastic structure.

8. (canceled)

9. The fluid filter assembly of claim 1 wherein there is a one-to-one correspondence in the number of first forms and the number of second forms.

10. The fluid filter assembly of claim 9 wherein at least one first form of said plurality of first forms has an interference fit with its corresponding one of said plurality of second forms.

11-13. (canceled)

14. A fluid filter assembly for the processing of a circulating fluid, said fluid filter comprising:
a unitary, molded plastic shell including an annular sidewall that defines an interior space and an annular entrance opening at one end of said shell, said sidewall including an exposed edge adjacent said entrance opening;
a fluid filter cartridge installed into said shell resulting from insertion of said fluid filter cartridge into said interior space via said entrance opening, said fluid filter cartridge including a filtering media element and a unitary, molded plastic endplate that is attached to one end of said filtering media element; and
positioning means for fixing the axial depth of said fluid filter cartridge into said shell, said positioning means including a plurality of recessed slots defined by said exposed upper edge and including a plurality of outwardly-extending projections that are molded as part of said endplate, each of said plurality of projections being constructed and arranged to fit into a corresponding one of said plurality of recessed slots for fixing the position of said fluid filter cartridge relative to said shell.

15. The fluid filter assembly of claim 14 wherein there is a one-to-one correspondence in the number of recessed slots and the number of outwardly-extending projections.

16. The fluid filter assembly of claim 15 wherein at least one recessed slot of said plurality of recessed slots has an interference fit with its corresponding outwardly-extending projection.

17. The fluid filter assembly of claim 16 wherein said interior space of said shell is open.

18. The fluid filter assembly of claim 17 wherein said shell is a unitary, molded plastic structure, and wherein said endplate is a unitary molded plastic structure.

19-20. (canceled)

21. The fluid filter assembly of claim 14 wherein said interior space of said shell is open.

22. A replaceable, fluid filter cartridge for installation into an open shell, said open shell having an upper annular edge defining a generally circular insertion opening with an outside diameter dimension, the open shell having an outer surface defining an external thread that terminates substantially adjacent to the upper annular edge, said fluid filter cartridge comprising:
a filter media pack; and
an endplate bonded to one end of said filter medial pack, said endplate being constructed and arranged with a plurality of outwardly-extending projections having an outside diameter dimension that exceeds the outside diameter dimension of said generally circular insertion opening.

23. The fluid filter assembly of claim 3 wherein the exposed upper edge further defines a clearance space within at least one of the open receiving slots of said plurality of first forms.

24. The fluid filter assembly of claim 23, wherein a radially outer surface of the sidewall defines an external threading that terminates substantially adjacent the exposed upper edge.

25. The fluid filter assembly of claim 23, wherein the assembly includes a plurality of flow clearance spaces, each flow clearance space being defined between an outer perimeter of the endplate and a radially inner surface of the sidewall between each pair of adjacent cooperatively interfit open receiving slot and radially outwardly extending projection.

26. The fluid filter assembly of claim 1, wherein a radially outer surface of the sidewall defines an external threading that terminates substantially adjacent the exposed upper edge.

27. The fluid filter assembly of claim 14 wherein the exposed upper edge further defines a clearance space within at least one of the plurality of recessed slots defined by said exposed upper edge.

28. The fluid filter assembly of claim 27, wherein the assembly includes a plurality of flow clearance spaces, each flow clearance space being defined between an outer perimeter of the endplate and a radially inner surface of the sidewall between each pair of radially outwardly extending projection fit into the corresponding open receiving slot.

29. The fluid filter assembly of claim 14, wherein a radially outer surface of the sidewall defines an external threading that terminates substantially adjacent the exposed upper edge.
